(19) United States
(12) Patent Application Publication
(10) Pub. No.: US 2024/0188668 A1
(43) Pub. Date: Jun. 13, 2024

(54) Helmet With Lock Assembly Device

(71) Applicant: Michael Arrington, Brookings, OR (US)

(72) Inventor: Michael Arrington, Brookings, OR (US)

(21) Appl. No.: 18/079,347

(22) Filed: Dec. 12, 2022

(51) Int. Cl. A42B 3/04; A42B 3/08; E05B 37/00; E05B 73/00

(52) U.S. Cl. CPC A42B 3/0413; A42B 3/08; E05B 37/0068; E05B 73/0011

(57) ABSTRACT

A helmet with lock assembly device for coupling to a bicycle helmet includes a helmet removably positioned on a head of a user. A strap is coupled to the helmet and releasably retains the helmet to the head of the user. A lock assembly is coupled to the helmet and includes a combination lock and a cord. The cord is releasably coupled to the combination lock and releasably secures the helmet to an extrinsic structure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to bicycle locks and more particularly pertains to a new bicycle lock for coupling to a bicycle helmet.

### (2) Description of Related Art Including Information Disclosed Under 37 CFR 1.97 and 1.98

The prior art relates to bicycle locks and includes a variety of bicycle locks removably securing a bicycle to a fixed structure to prevent theft of the bicycle. Known prior art lacks a bicycle lock comprising a combination lock and being coupled to a bicycle helmet to secure the bicycle and helmet to the fixed structure to prevent theft of both the bicycle and helmet.

### BRIEF SUMMARY OF THE INVENTION

An embodiment of the disclosure meets the needs presented above by generally comprising a helmet configured to be removably positioned on a head of a user. A strap is coupled to the helmet and is configured for releasably retaining the helmet to the head of the user. A lock assembly is coupled to the helmet and includes a combination lock and a cord. The cord is releasably coupled to the combination lock and is configured for releasably securing the helmet to an extrinsic structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a helmet with lock assembly device according to an embodiment of the disclosure.

FIG. 2 is a back perspective view of an embodiment of the disclosure.

FIG. 3 is a side view of an embodiment of the disclosure.

FIG. 4 is a cross-sectional view of an embodiment of the disclosure taken along Line 4-4 of FIG. 3.

FIG. 5 is a bottom view of an embodiment of the disclosure.

FIG. 6 is an in-use view of an embodiment of the disclosure.

FIG. 7 is an in-use view of an embodiment of the disclosure.

### DETAILED DESCRIPTION OF THE INVENTION

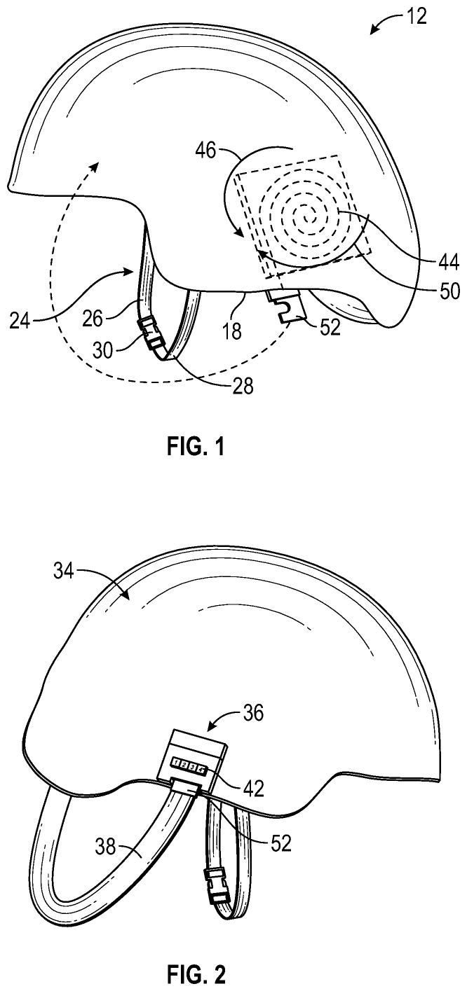

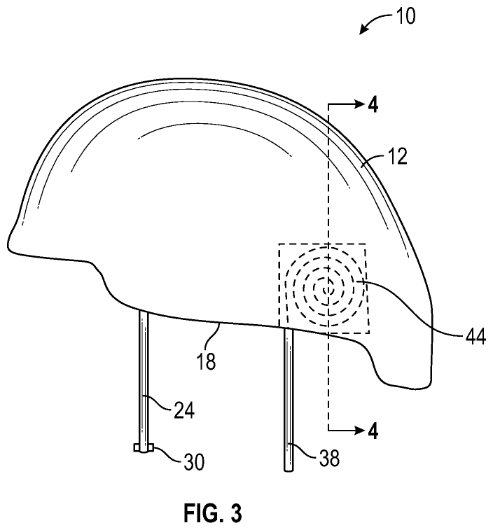

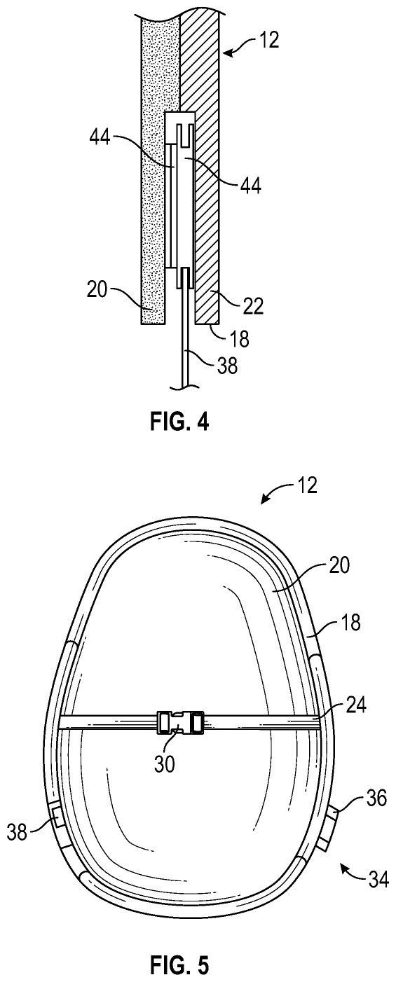

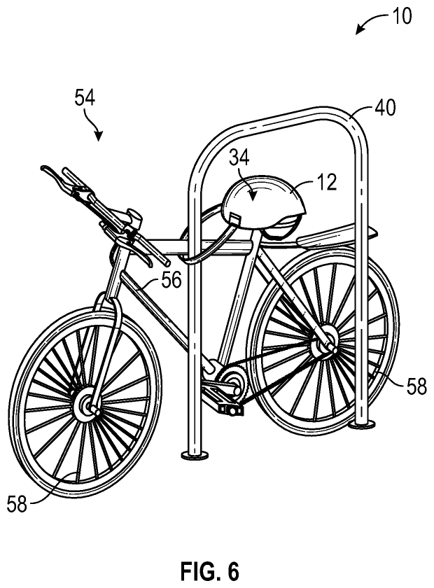

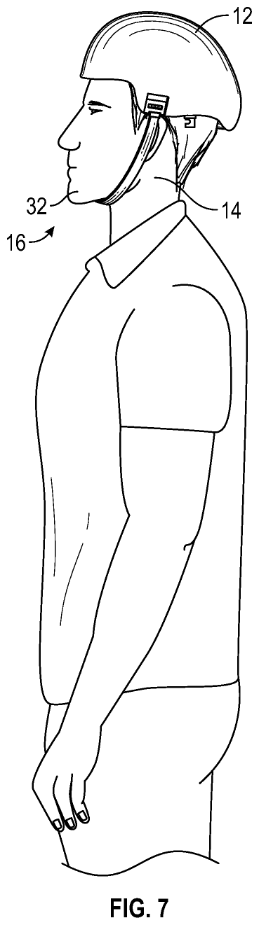

With reference now to the drawings, and in particular to FIGS. 1 through 7 thereof, a new bicycle lock embodying the principles and concepts of an embodiment of the disclosure and generally designated by the reference numeral 10 will be described.

As best illustrated in FIGS. 1 through 7, the helmet with lock assembly device 10 generally comprises a helmet 12 configured to be removably positioned on a head 14 of a user 16. The helmet 12 includes a shell comprising a semispherical shape and has a perimeter edge 18. The shell includes an inner layer 20 and an outer layer 22 and the inner layer 20 is configured for abutting the head 14 of the user 16. The inner layer 20 normally comprises a resiliently compressible material such as foam. The outer layer 22 typically comprises a rigid material being durable and being resistant to breaking from an impact force.

A strap 24 is coupled to the helmet 12 and is configured for releasably retaining the helmet 12 to the head 14 of the user 16. The strap 24 includes a first element 26 and a second element 28. The first element 26 and the second element 28 are coupled to the perimeter edge 18 and are positioned opposite to each other on the perimeter edge 18. The strap 24 has a buckle 30 for releasably attaching the first 26 and second 28 elements to each other. The strap 24 is normally positioned under a chin 32 of the user 16.

A lock assembly 34 is coupled to the helmet 12 and includes a combination lock 36 and a cord 38. The cord 38 is releasably fastened to the combination lock 36 and is configured for releasably securing the helmet 12 to an extrinsic structure 40 such as a bicycle rack. The combination lock 36 is mounted to the outer layer 22 of the helmet 12 and is positioned adjacent to the perimeter edge 18 of the shell. The combination lock 36 includes a combination dial 42, wherein the combination dial 42 unlocks the combination lock 36 when the combination dial 42 receives a code. The code normally comprises a set of numbers positioned in a distinct sequence.

A spool 44 is rotatably coupled to the helmet 12 and is wound with the cord 38, wherein the cord 38 extends outwardly from the helmet 12 to rotate the spool 44 in a first direction 46. The spool 44 is normally positioned between the outer 22 and inner 20 layers of the helmet 12 and may be positioned adjacent to the perimeter edge 18 of the shell. The spool 44 is normally positioned opposite to the combination lock 36 upon the helmet 12. A retractor spring 48 is mechanically coupled to the spool 44 to bias rotation of the spool 44 in a second direction 50 to draw the cord 38 inwardly towards the helmet 12. A latch 52 for the combination lock 36 is attached to an end of the cord 38 and releasably secures to the combination lock 36.

In use, the helmet 12 is positioned on the head 14 of the user 16 and secured to the user 16 by the strap 24. The helmet 12 is configured for reducing injury to the head 14 of the user 16 when the user 16 receives an impact force to the head 14 such as when the user 16 falls off a bicycle 54 onto their head 14. When the helmet 12 is removed from the user 16, the cord 38 may be threaded through a frame 56 or a wheel 58 of the bicycle 54 prior to securing the latch 52 of the cord 38 with the combination lock 36 to the extrinsic structure 40, wherein inhibiting the helmet 12 and the bicycle 52 to theft.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A helmet with a lock assembly comprising:
a helmet configured to be removably positioned on a head of a user;
a strap being coupled to said helmet and being configured for releasably retaining said helmet to the head of the user;
a lock assembly being coupled to said helmet and including a combination lock and a cord, said cord being releasably fastened to said combination lock and being configured for releasably securing said helmet to an extrinsic structure.

2. The helmet with a lock assembly of claim 1, wherein said helmet includes a shell, said shell comprising a semispherical shape and having a perimeter edge, said shell including an inner layer and an outer layer, said inner layer being configured for abutting the head of the user.

3. The helmet with lock assembly of claim 2, wherein said inner layer comprises a resiliently compressible material, said outer layer comprising a rigid material, said rigid material being durable and being resistant to breaking from an impact force.

4. The helmet with a lock assembly of claim 2, wherein said strap includes a first element and a second element, said first element and said second element being coupled to said perimeter edge and being positioning opposite to each other on said perimeter edge.

5. The helmet with a lock assembly of claim 4, wherein said strap has a buckle for releasably attaching said first and second elements to each other.

6. The helmet with a lock assembly of claim 1, wherein said combination lock includes a combination dial, wherein said combination dial unlocks said combination lock when said combination dial receives a code.

7. The helmet with a lock assembly of claim 6, further including a latch for said combination lock being attached to an end of said cord and releasably securing with said combination lock.

8. The helmet with a lock assembly of claim 2, further including a spool being rotatably attached to said helmet and winding said cord, wherein said cord extends outwardly from said helmet to rotate said spool in a first direction.

9. The helmet with a lock assembly of claim 8, wherein said spool is positioned between said outer and inner layers of said helmet, said spool being positioned adjacent to said perimeter edge of said shell, said spool being positioned opposite to said combination lock upon said helmet.

10. The helmet with a lock assembly of claim 9, further including a retractor spring being mechanically coupled to said spool to bias rotation of said spool in a second direction to draw said cord inwardly towards said helmet.

11. A helmet with a lock assembly comprising:
a helmet configured to be removably positioned on a head of a user, said helmet including a shell, said shell comprising a semispherical shape and having a perimeter edge, said shell including an inner layer and an outer layer, said inner layer being configured for abutting the head of the user, said inner layer comprising a resiliently compressible material, said outer layer comprising a rigid material, said rigid material being durable and being resistant to breaking from an impact force;
a strap being coupled to said helmet and being configured for releasably retaining said helmet to the head of the user, said strap including a first element and a second element, said first element and said second element being coupled to said perimeter edge and being positioning opposite to each other on said perimeter edge, said strap having a buckle for releasably attaching said first and second elements to each other;
a lock assembly being coupled to said helmet and including a combination lock and a cord, said cord being releasably fastened to said combination lock and being configured for releasably securing said helmet to an extrinsic structure, said combination lock being mounted to said outer layer of said helmet, said combination lock being positioned adjacent to said perimeter edge of said shell, said combination lock including a combination dial, wherein said combination dial unlocks said combination lock when said combination dial receives a code, a latch for said combination lock being attached to an end of said cord and releasably securing with said combination lock; and
a spool rotatably attaching to said helmet and winding said cord, wherein said spool rotates in a first direction to extend said cord outwardly from said helmet, said spool being positioned between said outer and inner layers of said helmet, said spool being positioned adjacent to said perimeter edge of said shell, said spool being positioned opposite to said combination lock upon said helmet, a retractor spring being mechanically coupled to said spool to bias rotation of said spool in a second direction to draw said cord inwardly towards said helmet.
